(19) United States
(12) Patent Application Publication
(10) Pub. No.: US 2015/0006113 A1
(43) Pub. Date: Jan. 1, 2015

(54) METHOD AND DEVICE FOR ESTIMATING LIGHT SCATTERING

(71) Applicant: THOMSON LICENSING, Issy de Moulineaux (FR)

(72) Inventors: Pascal Gautron, Rennes (FR); Jean-Eudes Marvie, Betton (FR); Cyril Delalandre, Montreuil le Gast (FR)

(73) Assignee: Thomson Licensing, Princeton, NJ (US)

(21) Appl. No.: 14/371,175

(22) PCT Filed: Dec. 17, 2012
(86) PCT No.: PCT/EP2012/075804

§ 371 Date: Jul. 8, 2014

(30) Foreign Application Priority Data
Jan. 10, 2012 (EP) 1230502808

(51) Int. Cl. G01J 3/44; G01J 1/42

(52) U.S. Cl. CPC G01J 3/4412; G01J 1/42
USPC 702/189

(57) ABSTRACT

A method and device for estimating the quantity of light received by an element of at least a participating medium belonging to a light ray crossing the at least a participating medium and having as origin a light source. As to optimize the estimation and the rendering of the at least a medium, the method comprises determining a pseudo-metric function according to intersection points between the participating medium and the light ray, the pseudo-metric function representing the distance only along the part(s) of the light ray crossing the participating medium; estimating first projection coefficients in a functions basis, the first coefficients being representative of an extinction function along the light ray according to the pseudo-metric function; and estimating the quantity of light received by the element according to the first projection coefficients.

### 1. DOMAIN OF THE INVENTION

The invention relates to the domain of image synthesis and more specifically to the domain of lighting simulation in a virtual environment comprising one or more participating media. The invention is also understood in the context of special effects for a live composition.

### 2. PRIOR ART

According to the prior art, different methods exist for estimating the quantity of light received and scattered in participating media such as for example fog, smoke, dust or clouds. Participating media correspond to media composed of particles in suspension that interact with the light modifying particularly the trajectory and intensity.

Participating media can be broken down into two groups, namely homogenous media such as water and heterogeneous media, such as smoke or clouds. In the case of homogenous participating media, it is possible to calculate analytically the attenuation of the light transmitted by a light source. In fact, due to their homogenous nature, these media have parameters such as the light absorption coefficient or the light scattering coefficient that are constant at any point of the media. Conversely, the light absorption and scattering properties vary from one point to another in a heterogeneous participating media. The calculations required to simulate the scattering of light in such heterogeneous media are then very costly and it is thus not possible to calculate analytically and interactively the quantity of light scattered by a heterogeneous participating medium. In addition, the media not being isotropic (that is to say the scattering of the media being anisotropic), the quantity of light scattered by the media also varies according to the scattering direction of the light, that is to say the direction in which a person views the media. Calculations estimating the quantity of light scattered must then be reiterated for each observation direction of the media by a person in order to obtain a realistic rendering of the media.

To produce the live display of heterogeneous participating media, some methods perform the pre-calculation of some parameters representative of the heterogeneous participating media. Though these methods are perfectly adapted for a studio use in post-production for example and provide a good quality display, these methods are not adapted in the context of live interactive conception and composition of a heterogeneous participating media. Such a method is described for example in the patent application WO2009/003143 filed by Microsoft Corporation and published on 31 Dec. 2008. The purpose of the application WO2009/003143 is a live display application for a heterogeneous media and describes a solution using radial base functions. This solution cannot however be considered as a live display solution as some pre-processing must be applied offline to the participating media to be able to calculate projection coefficients representing the media that will be used for image synthesis live calculations.

With the emergence of interactive simulation games and applications, notably in three dimensions (3D), the need is being felt for live simulation methods offering a realistic display of heterogeneous participating media.

### 3. SUMMARY OF THE INVENTION

The purpose of the invention is to overcome at least one of these disadvantages of the prior art.

More specifically, the purpose of the invention is to optimize the required calculation time to compose a realistic live display of the light passing through one or more participating media.

The invention relates to a method for estimating the quantity of light received by at least an element of at least a participating medium, the at least an element belonging to a light ray crossing the at least a participating medium and having as origin a light source. The method comprises the steps of:
determining a pseudo-metric function according to intersection points between the at least a participating medium and the light ray, the pseudo-metric function being determined in such a way as to be representative of distance only along the part of the light ray crossing the at least a participating medium,
estimating first projection coefficients in a functions basis, the first coefficients being representative of an extinction function along the light ray according to the pseudo-metric function,
estimating the quantity of light received by the at least an element according to the first projection coefficients.

Advantageously, the pseudo-metric function is increasing inside the at least a participating medium and stationary outside the at least a participating medium.

According to a specific characteristic, the pseudo-metric function is determined from a first function that is equal to zero for each element of the light ray not belonging to the at least a participating medium and different from zero for elements of the light ray belonging to the at least a participating medium.

According to a specific characteristic, the first function is equal to 1 for the elements of the light ray belonging to the at least a participating medium.

Advantageously, the first function is a derivative of the pseudo-metric function.

According to a specific characteristic, the method comprises a step of estimating second projection coefficients in a functions basis, the second projection coefficients being representative of the first function.

Advantageously, the pseudo-metric function is determined according to the second projection coefficients.

According to a particular characteristic, the first projection coefficients are estimated by projecting the extinction function into the function basis with respect to the pseudo-metric function.

According to another characteristic, the at least a participating medium is homogeneous or heterogeneous.

Advantageously, the first projection coefficients are stored in a projective texture.

According to a specific characteristic, the method comprises a step of estimating values representative of the reduction of light intensity for elements of the light ray from the first projection coefficients.

The invention also relates to a device configured for estimating the quantity of light received by at least an element of at least a participating medium, the at least an element belonging to a light ray crossing the at least a participating medium and having as origin a light source, the device comprises at least a processor configured for:
determining a pseudo-metric function according to intersection points between the at least a participating medium and the light ray, the pseudo-metric function being determined in such a way as to be representative of distance only along the part of the light ray crossing the at least a participating medium,
estimating first projection coefficients in a functions basis, the first coefficients being representative of an extinction function along the light ray according to said pseudo-metric function,
estimating the quantity of light received by the at least an element according to the first projection coefficients.

Advantageously, the at least a processor is a Graphics Processing Unit.

The invention also relates to a computer program product, which comprises instructions of program code for executing the steps of the above method, when the program is executed on a computer.

### 4. LIST OF FIGURES

The invention will be better understood, and other specific features and advantages will emerge upon reading the following description, the description making reference to the annexed drawings wherein:

FIG. 1 diagrammatically shows a ray of light passing through a plurality of participating media, according to a particular embodiment of the invention,

FIG. 2 diagrammatically shows a participating media of FIG. 1 scattering light, according to a particular embodiment of the invention,

FIGS. 3A and 3B diagrammatically show the variations in extinction of light along the light ray of FIG. 1, according to two particular embodiments of the invention,

FIGS. 4A and 4B diagrammatically show a method for estimating a function representative of the distance along the light ray of FIG. 1, according to two particular embodiments of the invention,

FIG. 5 diagrammatically shows the variations in extinction of light along the light ray of FIG. 1 with respect to the function representative of distance of FIGS. 4A and 4B, according to a particular embodiment of the invention,

FIG. 6 diagrammatically shows a device implementing a method for estimation of the quantity of light received by a point of a participating media located on the light ray of FIG. 1, according to a particular embodiment of the invention,

FIG. 7 shows a method for estimation of the quantity of light received by a point located on the light ray of FIG. 1, implemented in the device of FIG. 6, according to a particular embodiment of the invention.

### 5. DETAILED DESCRIPTION OF EMBODIMENTS OF THE INVENTION

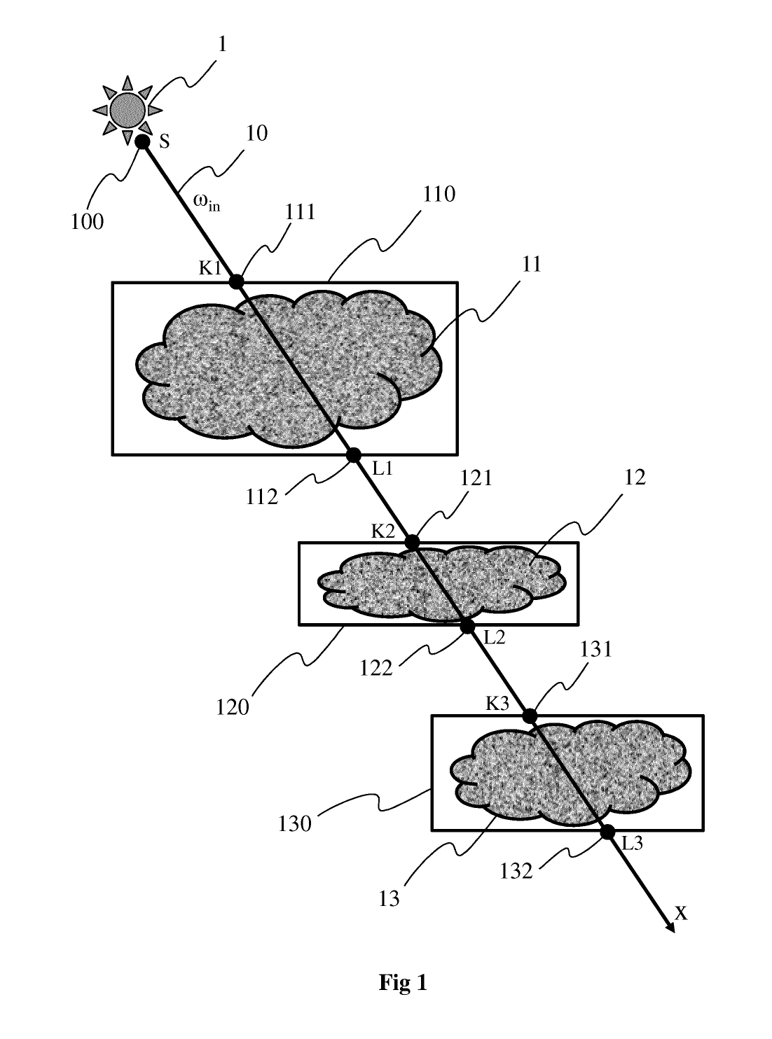

FIG. 1 illustrates a virtual environment or a virtual scene lit by a light source 1. The virtual environment comprises one or several virtual objects, some of the virtual objects corresponding to participating media 11, 12, 13, for example clouds. The participating media are crossed by a light ray 10 having as origin the light source 1, the light ray corresponding to an incident ray of light ωᵢₙ. Each of the participating media 11, 12, 13 is surrounded by a bounding box, respectively referenced 110, 120, 130. The bounding box enables to easily estimate the intersection points between the light ray 10 and the participating media 11, 12, 13. The light ray 10 enters the first participating media 11 at point K1 111 and gets out of the first participating media 11 at point L1 112. The light ray 10 enters the second participating media 12 at point K2 121 and gets out of the second participating media 12 at point L2 122. The light ray 10 enters the third participating media 13 at point K3 131 and gets out of the third participating media 13 at point L3 132. Intersection points K1 111, L1 112, K2 121, L2 122, K3 131 are determined through any geometric method known by the skilled person in the art. When assimilating the light source 1 to a single point S 100, the distance separating the light source 1 and the first participating media 11 corresponds to the norm of the segment [SK1]. The distance crossed in the first participating media 11 by the light ray 10 corresponds to the norm of the segment [K1L1]. The distance crossed in the second participating media 12 by the light ray 10 corresponds to the norm of the segment [K2L2]. The distance crossed in the third participating media 13 by the light ray 10 corresponds to the norm of the segment [K3L3]. The distance separating the first 11 and second 12 participating media along the light ray 10 corresponds to the norm of the segment [L1K2] and the distance separating the second 12 and third 13 participating media along the light ray 10 corresponds to the norm of the segment [L2K3].

The virtual environment may be represented with a set of elements, an element corresponding for example to a point or a particle, a density value being associated with each element. A particle is advantageously assimilated to a sphere that is characterized by its centre and an influence radius. A particle groups a set of points together, the points of the set of points having same or similar characteristics (for example a same density). When represented with points, a density value is associated with each point of the virtual environment. When represented with particles, a density value is associated with each particle of the virtual environment.

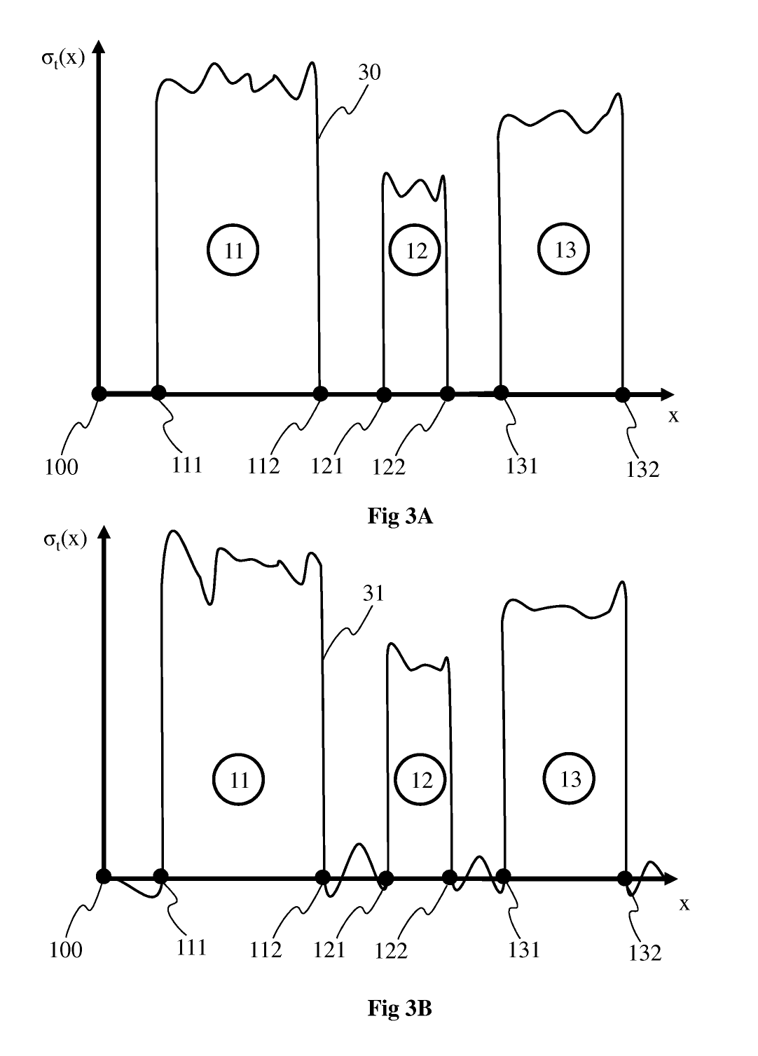

Advantageously, the virtual environment is represented with a set of extinction coefficients associated with the elements forming the virtual environment. FIG. 3A illustrates an extinction function σₜ(x) 30 along the light ray ωᵢₙ 10, x corresponding to the distance along the light ray 10 starting from the light source 1 represented by the point S 100. The extinction function σₜ(x) corresponds to the variations of the extinction coefficients values associated with elements of the virtual environment according to the distance x crossed along the light ray 10. The function σₜ(x) 30 takes the value 0 for x not belonging to the participating media 11, 12 and 13, which means that there is no extinction of light outside the participating media. This is the case when x belongs to the light ray segments [SK1], [L1K2] and [L2K3], the points S, L1, K2, L2 and L3 being represented with their reference numbers on FIG. 3A, i.e. respectively 100, 111, 112, 121, 122 and 131 also used with regard to FIG. 1. One observes important variations when the light ray enters and goes out of a participating media, i.e at points K1 111, L1 112, K2 121, L2 122, K3 131 and L3 132. Inside the participating media 11, 12 and 13, one observes smaller variations of the extinction coefficients values, these variations being dependent from the variations of the density values associated with the elements of the participating media crossed by the light ray 10, the participating media being heterogeneous in this example. According to another example, the participating media 11, 12, 13 are homogeneous (or one (or more) of them is (are) homogeneous) and there is no variation regarding the extinction coefficients values inside the participating media, the only variations being observed when the light ray enters and goes out of the participating media at points 111, 112, 121, 122, 131 and 132.

FIG. 3B illustrates the extinction function σₜ(x) 31 according to distance x crossed along the light ray ωᵢₙ 10 which corresponds to the extinction function σₜ(x) 30 of FIG. 3A but represented or projected into a function basis, for example a Discrete Cosine Transform (DCT). As explained in patent application WO2012000847, published on Jan. 5, 2012, a method for projecting the extinction coefficients along a ray into a set of basis functions bᵢ(x) computes a set of first projection coefficients. As described in WO2012000847, each function f(x) (for example the function representative of extinction or the function representative of density) of the functional space can be written as a linear combination of N base functions, a base function being a base element for a functional space:

ƒ(x)=Σᵢ₌₀^{N}cᵢbᵢ(x) equation 1
wherein cᵢ is the i^{th} coefficient of the basis function bᵢ defined with:

cᵢ≈∫ƒ(x)bᵢ(x) equation 2
Which gives when f(x) is the extinction function σₜ(x):

cᵢ≈=∫σₜ(x)bᵢ(x)dx equation 3

σₜ(x)=Σᵢ₌₀^{N}cᵢbᵢ(x) equation 4

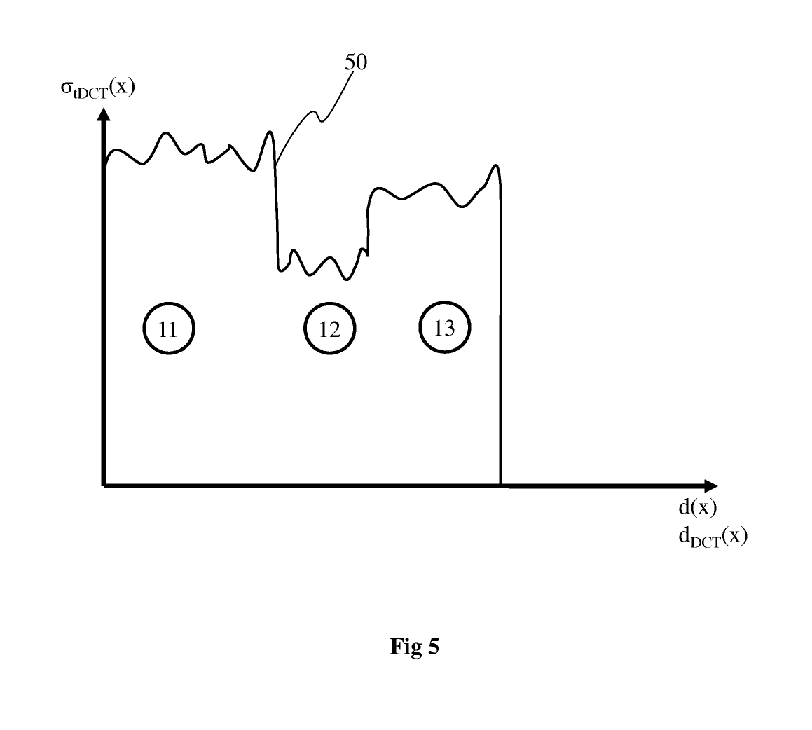

The extinction function σₜ(x) along the light ray is thus represented with a set of first projection coefficients cᵢ which enable to compute the value of any extinction coefficient value associated with any elements of the virtual environment along the light ray 10. The representation of the extinction function σₜ(x) in the function basis has the advantage of simplifying and speeding up the computations needed for estimating light intensity attenuation inside the participating media and also of reducing the footprint on memory (as explained with more details with regard to FIG. 5). Indeed, instead of storing an extinction coefficient value for each element of the virtual environment crossed by the light ray 10, it is only needed to store a set of first projection coefficients associated with the light ray 10, any extinction coefficient value being computable from the set of first projection coefficients. The representation of the extinction function σₜ(x) in the function basis according to x has nevertheless the drawback of presenting oscillations (between the light source S 100 and the first participating media 11 and between the participating media themselves, i.e. on the segments [SK1], [L1K2] and [L2K3] of the light ray 10 and at the output of the third participating media 13 at point 132, the points S, L1, K2, L2 and L3 being represented with their reference numbers on FIG. 3B, i.e. respectively 100, 111, 112, 121, 122 and 131 also used with regard to FIGS. 1 and 3A) which generate visible artifacts when rendering the virtual environment as the extinction coefficient values on the segments [SK1], [L1K2] and [L2K3] are incorrect. These oscillations are mainly due to the hollow spaces along the light ray 10 between the light source S 100 and the first participating media 11 and between the participating media themselves, the hollow spaces being represented by the segments [SK1], [L1K2] and [L2K3] and after exiting the third participating media 13.

Naturally, the number of participating media is not limited to 3 but may be any number higher than or equal to 1. When equal to 1, the oscillation problem appears mainly before entering the participating medium and after going out of the participating medium.

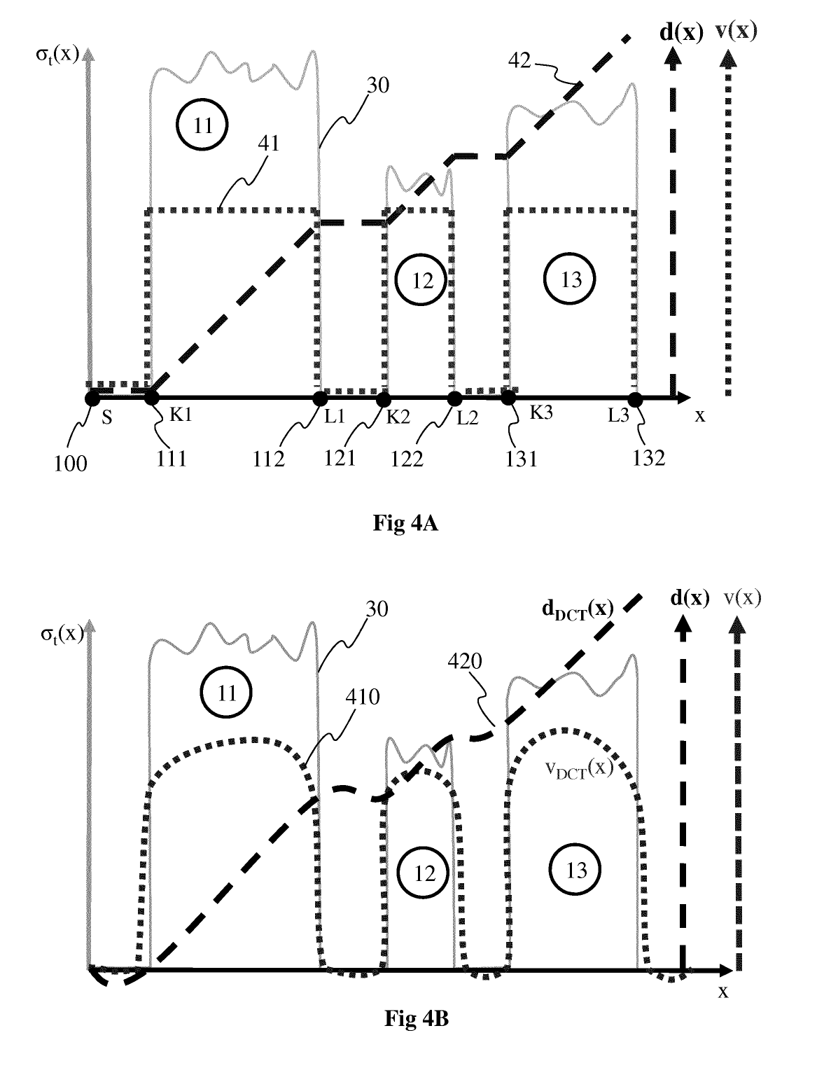

As to overcome the oscillation problem, the invention proposes to remap the distance x with a distance function d(x) as to avoid hollow spaces or gaps which appear along the light ray between the light source and the participating medium 11 and between two participating media (respectively between 11 and 12, between 12 and 13) and also after exiting the last participating medium 13 crossed by the light ray 10, for example on the segments [SK1], [L1K2], [L2K3] and [L3 . . . ]. Such a distance remapping is illustrated according to an advantageous embodiment with regard to FIGS. 4A, 4B and 5.

FIG. 4A illustrates a first embodiment for determining a pseudo-metric function d(x) 42 representative of the distance along the light ray 10. The function d(x) 42 is represented with a segmented line on FIG. 4A. The pseudo-metric function d(x) 42 is such that the distance along the light ray increases when inside a participating medium 11, 12 and 13 and is stationary outside any participating media. Unlike a metric function (representative of an Euclidian distance) which is strictly increasing, a pseudo-metric function has the advantage of being monotonic with one or more stationary parts. The pseudo-metric function is advantageously determined according to the intersection points K1 111, L1 112, K2 121, L2 122, K3 131 and L3 132 between the light ray 10 and the participating media 11, 12, 13, with regard to x. For an element M1 (a point, a particle or a ray sample if the light ray 10 is discretized into a number Y of samples) belonging to the light ray 10 and to the first participating medium 11, the value representative of distance of d(x) associated with the point M1 corresponds to the distance between K1 111 and M1 as K1 is the entry point of the light ray into the first participating medium 11. This distance may be computed according to the coordinates associated with M1 and K1 in a same space (for example the world space or the space of the light ray). According to another example, this distance corresponds to the difference between x associated with M1 (noted x_{M1}) and x associated with K1 (noted x_{K1}). For an element M2 belonging to the light ray 10 and to the second participating medium 12, the value representative of distance of the function d(x) associated with the point M2 corresponds to the sum of the distance ∥K1L1∥ and the distance between K2 121 and M2 as K2 is the entry point of the light ray into the second participating medium 12. For an element M3 belonging to the light ray 10 and to the third participating medium 13, the value representative of distance of the function d(x) associated with the point M3 corresponds to the sum of the distance ∥K1L1∥, the distance ∥K2L2∥ and the distance between K3 131 and M3 as K3 is the entry point of the light ray 10 into the third participating medium 13. As to determine d(x), the value of d(x) is advantageously determined for each element M located along the light ray and belonging to the participating media. According to a variant, the value of d(x) is advantageously determined for a part of the elements M located along the light ray and belonging to the participating media, the rest of the values of d(x) being for example determined by interpolating two determined values of d(x) surrounding the value to be determined by interpolation.

According to a variant, the pseudo-metric function is determined by integrating a square function v(x) which takes different value according to the distance x, knowing the intersection points K1 111, L1 112, K2 121, L2 122, K3 131 and L3 132 between the light ray 10 and the participating media 11, 12, 13. The square function v(x) 42 is equal to zero when x belongs to a segment of the light ray 10 outside the participating media 11, 12 and 13 (i.e. [SK1], [L1K2], [L2K3] and [L3 . . . ]) and is different from zero when x belongs to a segment of the light ray inside a participating medium 11, 12 or 13 (i.e. [K1L1], [K2L2] and [K3L3]). The square function v(x) 41 is represented with a dotted line on FIG. 4A. The value taken by v(x) in the participating media is for example comprised between 0 and 1, 0 excluded or any value, 0 excluded, for example 1. For simplifying the computations needed for determining d(x) from v(x), the integration of v(x) is replaced with a sum of a finite number of elements.

FIG. 4B illustrates a second embodiment for determining the pseudo-metric function d(x). As to simplify and speeding up the computations needed for determining d(x), the square function v(x) defined with regard to FIG. 4A is first expressed with second projection coefficients representing the function v(x) 410 in a functions base, for example a DCT basis. The function v(x) once projected in the functions base (composed of N basis functions bᵢ) is defined with:

v(x)=Σᵢ₌₀^{N}dᵢbᵢ(x) equation 5

wherein dᵢ is the i^{th} coefficient of the basis function bᵢ defined with:

dᵢ=∫(x)bᵢ(x)dx equation 6

where v(x)=1 or any value different from 0 if x is within a participating medium and 0 otherwise. To obtain the pseudo-metric function d(x), v(x) is integrated, which gives:

d(x)=∫₀^{x}Σdᵢbᵢ(x)dx equation 7

d(x)=Σdᵢ∫₀^{x}bᵢ(x)dx equation 8

d(x)=Σdᵢ(Bᵢ(x)−Bᵢ(0)) equation 9

where Bᵢ is the primitive of bᵢ and Bᵢ(0) is the primitive of bᵢ at the level of the light source, i.e. at point S 100.

The function d(x) 420 obtained with the equation 9 and illustrated on FIG. 4B corresponds to d(x) 42 of FIG. 4A expressed (or projected) in a functions base (for example DCT). According to this second embodiment, it is neither necessary to store the attributes (for example the coordinates) associated with the intersection points between the light ray and the participating media 11, 12, 13 nor to determine the distance between any elements of the participating media along the light ray for estimating d(x).

FIG. 5 illustrates the extinction function σₜ(x) 50 (noted σ_{tDCT}(x) as expressed in a functions base (for example DCT) with its first projection coefficients) along the light ray 10 with respect to the function representative of distance d(x) or d_{DCT}(x), d_{DCT}(x) corresponding to d(x) but expressed in a functions base, such as DCT for example). As illustrated on FIG. 5, there is no gap between the light source and the first participating media and no gap between the participating media 11, 12, 13 either. Such a representation has the advantage of avoiding the oscillations appearing between the participating media and of enabling a representation on a distance scale adapted to the size of the participating media 11, 12, 13. Indeed, when the extinction function is expressed with regard to x, if the participating media are little in comparison to the distance between the light source and the first participating media crossed by the light ray emitted by the light source and/or in comparison to the gaps between the participating media, the distances on which the variation of extinction are represented (corresponding to the segments [K1L1], [K2L2] and [K3L3]) may be small or very small in comparison to the whole distance travelled by the light ray in the virtual environment. The details at the level of the extinction variation may thus be attenuated. In contrast, by representing the extinction function σₜ(x) 50 with regard to d(x), importance is given to the path crossed inside the participating media, and thus to the variation details. When expressed with regard to d(x), the first projection coefficients representative of the extinction function are obtained from equation 3 and are for a i^{th} projection coefficient cᵢ:

cᵢ=∫σₜ(d(x))bᵢ(d(x))d(d(x)) equation 10

From the first projection coefficients ci, the attenuation of the light intensity at a point M (noted Att_{L}(M)) of a participating media at a distance x of the light source and representing the quantity of incident light arriving at the point M after attenuation is easily computed with:

Att_{L}(M)=exp(∫₀^{x}−σₜ(x)d(x)) equation 11

which gives:

Att_{L}(M)=exp[−Σᵢcᵢ(Bᵢ(d(x))−Bᵢ(d(0)))] equation 12

Naturally, the number of light rays is not limited to 1 but extend to any number higher than 1, for example 100, 1000, 10000. The operation described with regard to FIGS. 3A, 3B, 4A and 4B may be repeated for each and every ray of light if needed.

The participating media 11, 12 and 13 may be seen as a single participating media when the extinction function is expressed with regard with the pseudo-metric function. If the participating media are all heterogeneous, the resulting one participating medium is also heterogeneous. If the participating media are all homogeneous, the resulting one participating medium may be homogeneous or heterogeneous (the resulting one participating medium is homogeneous if the density inside the participating media 11, 12 and 13 is the same for each and every participating media 11, 12 and 13; the resulting one participating medium is heterogeneous if the density inside the participating media 11, 12 and 13 varies from one participating medium to another one).

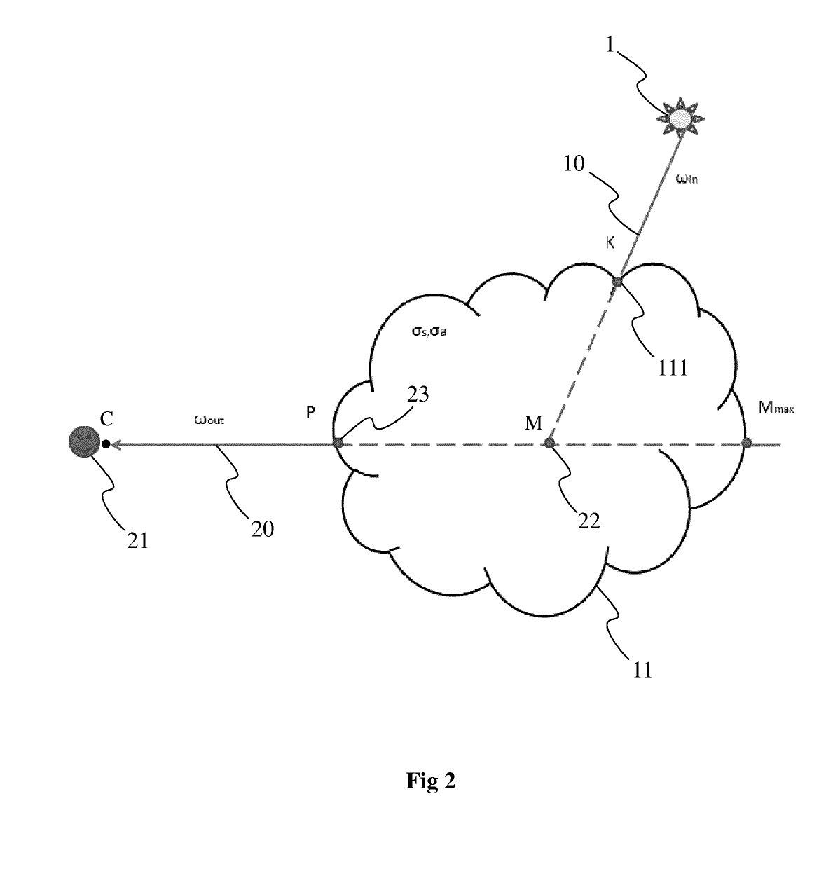

FIG. 2 shows a heterogeneous participating medium 11, corresponding for example to the first participating medium 11 of FIG. 1. A participating medium is a medium, composed of a multitude of particles in suspension that absorbs, emits and/or diffuses light. In its simplest form, a participating medium absorbs only light, for example the light received from a light source 1 such as the sun for example. This means that the light passing across the medium 11 is attenuated, the attenuation depending of the density of the media. The medium being heterogeneous, that is to say that the physical characteristics of the medium, such as the density of particles composing it for example, vary from one point to another in the media. As the participating medium is composed of small particles that interact with the light, the incident light, that is to say received from the light source 1 according to one direction ωᵢₙ 10 is not only absorbed but it is also scattered. In an isotropic scattering participating medium, the light is scattered uniformly in all directions. In an anisotropic scattering participating medium, such as a cloud, the light scattering depends on the angle between the incidence direction ωᵢₙ 10 and a scattering direction ωₒᵤₜ 20 of the light. The quantity of light scattered at a point M 22 of the medium 11 in the scattering direction ωₒᵤₜ 20 is calculated by the following equation:

Q(M,ωₒᵤₜ)=D(M)·σₛ·p(M,ωₒᵤₜ,ωᵢₙ)·Lᵣᵢ(M,ωᵢₙ) equation 13

The quantity of light scattered by a point M 22 of the media attaining the eye of the spectator 21 situated at a point C of space in the direction ωₒᵤₜ 20, that is to say the quantity of light scattered by the point M is attenuated by the medium 11 on the trajectory M-P, the point P being situated at the intersection of the medium 11 and the direction ωₒᵤₜ in the direction of the spectator 21, is then:

L_{P}(M,ωₒᵤₜ)=Q(M,ωₒᵤₜ)·exp^{∫}^{_{P}}^{^{M}}^{-D(s)·σ}^{ₜ}^{·ds} equation 14

wherein:
σₛ is the scattering coefficient of the medium,
σₐ is the absorption coefficient of the medium,
σₜ=σₛ+σₐ is the extinction coefficient of the medium,
D(M) is the density of the medium at a given point, the density varying from one point to another as the medium 11 is heterogeneous,
p(M,ωₒᵤₜ,ωᵢₙ) is the phase function describing how the light coming from the incidence direction ωᵢₙ is scattered in the scattering direction ωₒᵤₜ at the point M,
Lᵣᵢ(M,ωᵢₙ) is the reduced light intensity at the point M coming from the incidence direction ωᵢₙ 10 and represents the quantity of incident light arriving at the point M after attenuation due to the trajectory of the light in the medium 11 on the segment K-M, K being the intersection point between the medium 11 and the incidence ray ωᵢₙ 10, and its value is:

exp^{∫}^{_{M}}^{^{K}}^{-D(s)σ}^{ₜ}^{ds} equation 15
exp^{∫}^{_{P}}^{^{M}}^{-D(s)σ}^{ₜ}^{ds} represents the attenuation of scattered light due to the absorption and scattering along the path from P 23 to M 22.

Equation 14 enables the quantity of light scattered by a point M and attaining the eye of a spectator 21 situated on the direction ωₒᵤ to be calculated. To calculate the quantity of light received by a spectator looking in the direction ωₒᵤₜ, the sum of all the contributions of the set of points of the medium situated on the axis ωₒᵤₜ must be calculated, that is to say the points situated on the segment P-Mₘₐₓ, P and Mₘₐₓ being the two intersection points between the medium 11 and the direction ωₒᵤₜ 20. This total scattered light arriving at P 23 from the direction ωₒᵤₜ 20 due to simple scattering is then:

L(P,ωₒᵤₜ)=∫_{P}^{Mmax}Lₚ(M,ωₒᵤₜ)dM equation 16

In this case, it is considered that the light following the trajectory C-P is not attenuated.

This total scattered light is obtained by integration of contributions from all the points situated between P and Mₘₐₓ on a ray having ωₒᵤₜ as direction. Such an integral equation cannot be resolved analytically in general and even less so for a live estimation of the quantity of light scattered. The integral is evaluated digitally using the method known as ray-marching. In this method, the integration domain is discretized into a multitude of intervals of size δ_{M} and the following equation is obtained:

L(P,ωₒᵤₜ)≈Σ_{P}^{Mmax}L_{P}(M,ωₒᵤₜ)δ_{M} equation 17

Advantageously, the heterogeneous participating medium 11 is a three-dimensional element, shown in two dimensions on FIG. 2 for reasons of clarity.

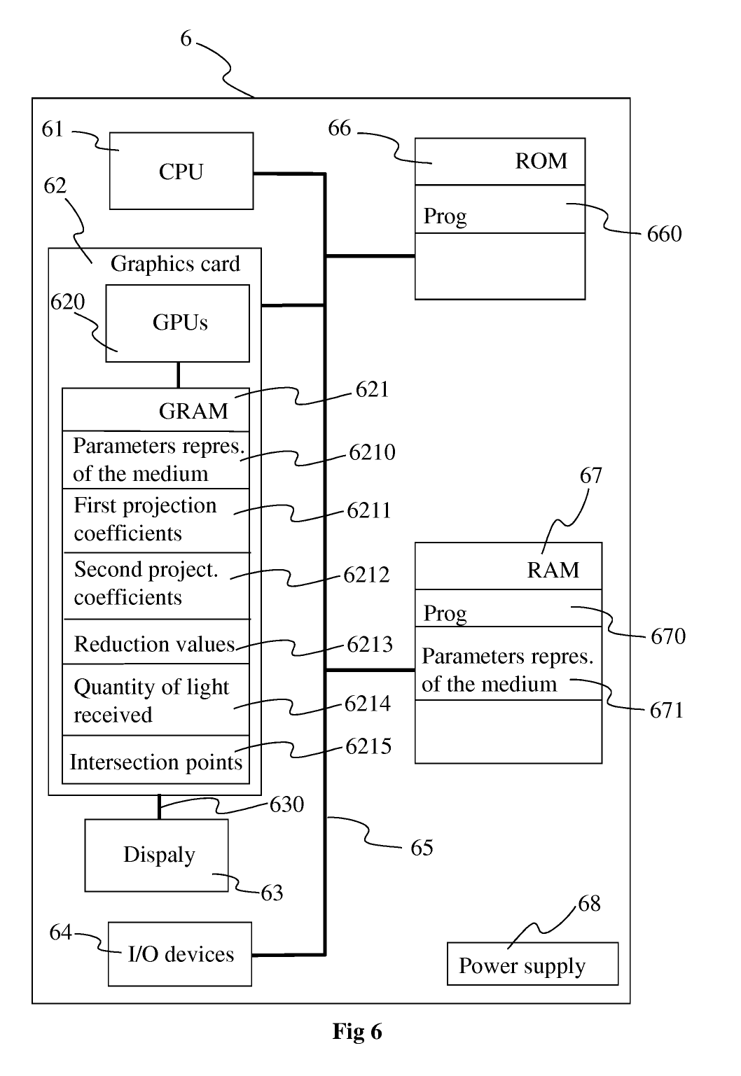

FIG. 6 diagrammatically shows a hardware embodiment of a device 6 adapted for the estimation of the quantity of light received by a point of a participating medium 11, 12 or 13. The device 6 corresponds for example, to a PC personal computer, a laptop or a games console.

The device 6 comprises the following elements, connected to each other by a bus 65 of addresses and data that also transports a clock signal:
a microprocessor 61 (or CPU),
a graphics card 62 comprising:
   several Graphical Processor Units (or GPUs) 620,
   a Graphical Random Access Memory (GRAM) 621,
a non-volatile memory of ROM (Read Only Memory) type 66,
a Random Access Memory or RAM 67,
one or several I/O (Input/output) devices 64 such as for example a keyboard, a mouse, a webcam, and
a power source 68.

The device 6 also comprises a display device 63 of display screen type directly connected to the graphics card 62 to display notably the display of synthesized images calculated and composed in the graphics card, for example live. The use of a dedicated bus to connect the display device 63 to the graphics card 62 offers the advantage of having much greater data transmission bitrates and thus reducing the latency time for the displaying of images composed by the graphics card. According to a variant, the display device is external to the device 6. The device 6, for example the graphics card, comprises a connector adapted to transmit a display signal to an external display means such as for example an LCD or plasma screen or video-projector.

It is noted that the word “register” used in the description of memories 62, 66 and 67 designates in each of the memories mentioned, both a memory zone of low capacity (some binary data) as well as a memory zone of large capacity (enabling a whole program to be stored or all or part of the data representative of data calculated or to be displayed).

When switched-on, the microprocessor 61 loads and executes the instructions of the program contained in the RAM 67.

The random access memory 67 notably comprises:
in a register 630, the operating program of the microprocessor 61 responsible for switching on the device 6,
parameters 671 representative of each of the participating media (for example parameters of density, of light absorption coefficients, of light scattering coefficients).

The algorithms implementing the steps of the method specific to the invention and described hereafter are stored in the memory GRAM 67 of the graphics card 62 associated with the device 6 implementing these steps. When switched on and once the parameters 670 representative of the environment are loaded into the RAM 67, the graphic processors 620 of the graphics card 62 load these parameters into the GRAM 621 and execute the instructions of these algorithms in the form of microprograms of “shader” type using HLSL (High Level Shader Language) language or GLSL (OpenGL Shading Language) for example.

The random access memory GRAM 621 notably comprises:
in a register 6210, the parameters representative of the medium/media,
first projection coefficients 6211 representative of the extinction function σₜ(x),
second projection coefficients 6212 representative of the square function v(x),
light intensity reduction values 6213,
values 6214 representative of the quantity of light received by a point of a participating medium according to one or several light rays,
parameters 6215 representative of intersection points between one or more light rays and the participating medium/media, for example the coordinates of the points.

According to a variant, a part of the RAM 67 is assigned by the CPU 61 for storage of the coefficients 6211 and 6212 and values 6212 to 6214 if the memory storage space available in GRAM 621 is insufficient. This variant however causes greater latency time in the composition of an image comprising a representation of the virtual environment composed from microprograms contained in the GPUs as the data must be transmitted from the graphics card to the random access memory 67 passing by the bus 65 for which the transmission capacities are generally inferior to those available in the graphics card for transmission of data from the GPUs to the GRAM and vice-versa.

According to another variant, the power supply 68 is external to the device 6.

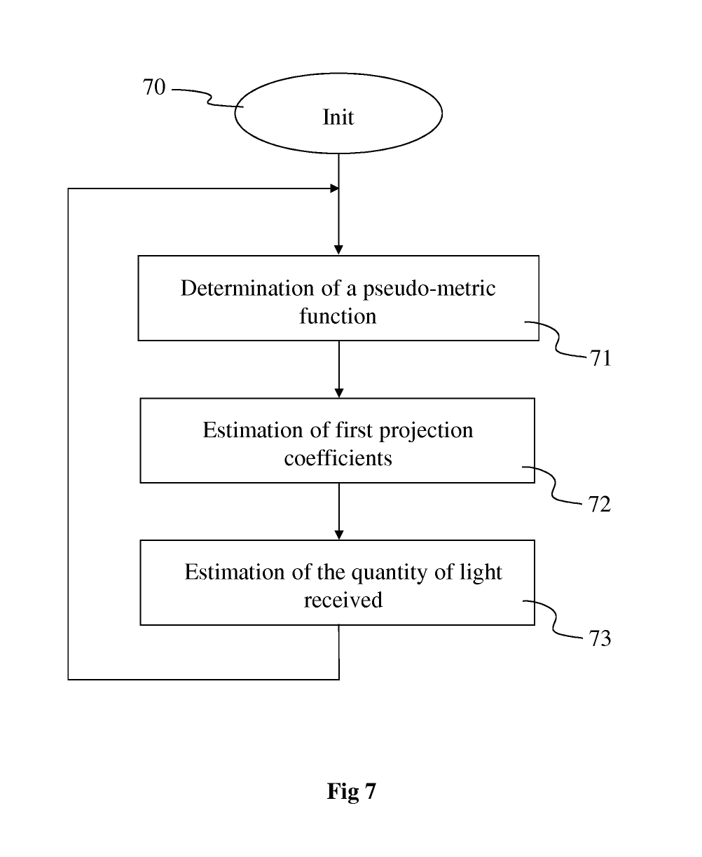

FIG. 7 shows a method for estimation of scattering of light in a heterogeneous participating medium implemented in a device 6, according to a non-restrictive embodiment of the invention.

During an initialization step 70, the different parameters of the device 6 are updated. In particular, the parameters representative of the participating media 11, 12 and/or 13 are initialized in any way.

Then, during a step 71, a pseudo-metric function is determined, the pseudo-metric function being representative of distance along the light ray but only for the parts of the light ray crossing the participating media. The pseudo-metric function is advantageously determined based on the intersection points between the participating media and the light ray. The pseudo-metric function d(x) is representative of the distance travelled by the light inside the participating media 11, 12, 13. A value representative of distance is assigned to the elements of each of the participating medium crossed by the light ray 10, an element of a participating medium corresponding to a point, a particle or a discretization sample according to the representation of the participating medium.

For an element, the value representative of distance is for example computed by estimating the distance travelled by the light along the light ray from the intersection point between the participating medium and the light ray where the light ray enters the participating medium. This value corresponds to the sum of the distances travelled by the light inside each and every participating medium before reaching the considered point to which is assigned the distance value without taking into account the distance travelled by the light along the light ray outside the participating media.

According to another example, the pseudo-metric function is determined by integrating a first function that is equal to zero for each element (i.e. each point or each particle or each sample according to the representation of the virtual environment comprising the participating medium/media) of the light ray 10 not belonging to the participating media and different from zero for elements of the light ray belonging to the participating medium. Said differently, the first function is a derivative of the pseudo-metric function. The first function is for example a square function (when the positive value different from zero associated with the elements of the light ray belonging to the participating medium is constant) or a positive function (when the positive value different from zero associated with the elements of the light ray belonging to the participating medium varies according to the elements). Advantageously, the value taken by the first function for elements of the light ray inside the participating medium/media is equal to 1.

According to a variant and as to simplify the computation involved in integrating the first function for determining the pseudo-metric function, the first function is expressed in a function base (composed of a plurality of basis functions). To that aim, a plurality of second projection coefficients are estimated, the second projection coefficients being representative of the first function. The second projection coefficients are estimated by projecting the first function into the function base along (or with respect to) the light ray. According to this variant, the pseudo-metric function is determined by using the second projection coefficients.

Then, during a step 72, first projection coefficients of a functions base are estimated, these first projection coefficients being representative of extinction coefficients, the values of which varying in the participating medium/media (as the density values associated with elements forming the participating media may vary). As to reduce the footprints on memory, a density value is used to weight a unique extinction coefficient as to simulate the variations of extinction inside the medium instead of varying the extinction coefficients themselves, as in RGB (for Red, Green and Blue) representation of the scene, the extinction coefficient normally may vary according to each of the color components R, G and B. To that aim, the function σₜ(x) representative of the variations in extinction in the participating medium/media is projected along the pseudo-metric function representative of distance inside the participating medium/media along the light ray and represented in a functional space of basis functions, for example by using a Fourier Transform or a Discrete Cosine Transform.

Advantageously, the first projection coefficients are stored in a projective texture. A storage space of the projective texture is assigned for the storage of the first projection coefficients associated with the light ray. A plurality of set of first coefficient projection are advantageously estimated for a plurality of light rays, for example as to cover the entire virtual environment, one set of first projection coefficients being associated with one light ray (a pseudo-metric function being determined for each light ray). In this case, a storage space of the projective texture is assigned for the storage of each set of first projection coefficients for each light ray.

Then, during a step 73, the quantity of light received by an element belonging to the participating medium (or to one of the participating media when more than one participating medium is crossed by the light ray 10) is then estimated according to the first projection coefficients associated with the part of light ray crossing the at least one participating medium. This is advantageously achieved by estimating a value representative of the reduction of light intensity (along the light ray) from the first projection coefficients, as explained with regard to equations 11 and 12.

Steps 71 to 73 are advantageously repeated for a plurality of light rays as to determine the quantity of light received by each and every element of the participating medium/media. According to a variant, the quantity of light received is estimated for only a part of the elements of the participating medium/media. According to this variant, the quality of the rendering of the participating medium/media will be less but could be acceptable if the participating medium/media are far from the point of view from which a spectator looks at the rendered virtual environment.

Naturally, the invention is not limited to the embodiments previously described.

In particular, the invention is not limited to a method for estimation of the quantity of light received by an element of a participating medium but also extends to any device implementing this method and notably any devices comprising at least one GPU. The implementation of equations described with respect to FIGS. 1 to 4 for the estimation of coefficients of projection, of reduction of light intensity in the incidence and emission directions, of the quantity of light received and scattered is also not limited to an implementation in shader type microprograms but also extends to an implementation in any program type, for example programs that can be executed in a CPU type microprocessor.

Advantageously, the base functions used for the estimation of projection coefficients are standard Fourier functions. According to a variant, the base functions used are Legendre polynomials or Tchebychev polynomials.

For example, the method implemented in a device comprising a Xeon® microprocessor with a 3.6 GHz rate nVidia geforce GTX580 graphics card enables the display to be composed of 40 images per second live for a heterogeneous participating medium of cloud type composed of 512³ elements. The use of the invention is not limited to a live utilization but also extends to any other utilization, for example for processing known as postproduction processing in a recording studio for the display of synthesis images for example. The implementation of the invention in postproduction offers the advantage of providing an excellent visual display in terms of realism notably while reducing the required calculation time.

The invention also relates to a method for composition/rendering of a video image, in two dimensions or in three dimensions, for which the quantity of light received by a participating medium is calculated and the information representative of the light that results is used for the displaying of pixels of the image, each pixel corresponding to an observation direction according to an observation direction ωₒᵤₜ. The calculated light value for displaying by each of the pixels of the image is re-calculated to adapt to the different viewpoints of the spectator.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

The present invention can be used in video game applications for example, whether via programs that can be executed in a PC or portable type computer or in specialized game consoles producing and displaying images live. The device 6 described with respect to FIG. 6 is advantageously equipped with interaction means such as a keyboard and/or joystick, other modes for introduction of commands such as for example vocal recognition being also possible.

1. A method of estimating a quantity of light received by at least an element of at least a participating medium, the at least an element belonging to a light ray crossing the at least a participating medium and having as origin a light source, wherein the method comprises:
determining a pseudo-metric function according to intersection points between the at least a participating medium and the light ray, the pseudo-metric function being determined in such a way as to be representative of distance only along the part of the light ray crossing the at least a participating medium,
estimating first projection coefficients in a functions basis, said first coefficients being representative of an extinction function along said light ray according to said pseudo-metric function,
estimating the quantity of light received by the at least an element according to said first projection coefficients.

2. The method according to claim 1, wherein the pseudo-metric function is increasing inside the at least a participating medium and stationary outside the at least a participating medium.

3. The method according to claim 1, wherein the pseudo-metric function is determined from a first function that is equal to zero for each element of the light ray not belonging to the at least a participating medium and different from zero for elements of the light ray belonging to the at least a participating medium.

4. The method according to claim 3, wherein the first function is equal to 1 for the elements of the light ray belonging to the at least a participating medium.

5. The method according to claim 3, wherein the first function is a derivative of the pseudo-metric function.

6. The method according to claim 3, further comprising estimating second projection coefficients in a functions basis, said second projection coefficients being representative of the first function.

7. The method according to claim 6, wherein said pseudo-metric function is determined according to the second projection coefficients.

8. The method according to claim 1, wherein the first projection coefficients are estimated by projecting the extinction function into the function basis with respect to the pseudo-metric function.

9. The method according to claim 1, wherein the at least a participating medium is homogeneous or heterogeneous.

10. The method according to claim 1, wherein said first projection coefficients are stored in a projective texture.

11. The method according to claim 1, further comprising estimating values representative of the reduction of light intensity for elements of said light ray from said first projection coefficients.

12. A device configured for estimating a quantity of light received by at least an element of at least a participating medium, the at least an element belonging to a light ray crossing the at least a participating medium and having as origin a light source, wherein the device comprises at least a processor configured for:
determining a pseudo-metric function according to intersection points between the at least a participating medium and the light ray, the pseudo-metric function being determined in such a way as to be representative of distance only along the part of the light ray crossing the at least a participating medium,
estimating first projection coefficients in a functions basis, said first coefficients being representative of an extinction function along said light ray according to said pseudo-metric function,
estimating the quantity of light received by the at least an element according to said first projection coefficients.

13. The device according to claim 12, wherein the at least a processor is a Graphics Processing Unit.

14. Computer program product, comprising instructions of program code for executing the steps of the method according to claim 1, when said program is executed on a computer.

15. The device according to claim 12, wherein the pseudo-metric function is increasing inside the at least a participating medium and stationary outside the at least a participating medium.

16. The device according to claim 12, wherein the pseudo-metric function is determined from a first function that is equal to zero for each element of the light ray not belonging to the at least a participating medium and different from zero for elements of the light ray belonging to the at least a participating medium.

17. The device according to claim 16, wherein the first function is equal to 1 for the elements of the light ray belonging to the at least a participating medium.

18. The device according to claim 16, wherein the first function is a derivative of the pseudo-metric function.

19. The device according to claim 16, wherein the at least one processor is further configured for estimating second projection coefficients in a functions basis, said second projection coefficients being representative of the first function.

20. The device according to claim 19, wherein said pseudo-metric function is determined according to the second projection coefficients.

21. The device according to claim 12, wherein the first projection coefficients are estimated by projecting the extinction function into the function basis with respect to the pseudo-metric function.

22. The device according to claim 12, wherein the at least a participating medium is homogeneous or heterogeneous.

23. The device according to claim 12, wherein the at least one processor is further configured for storing said first projection coefficients in a projective texture.

24. The device according to claim 12, wherein the at least one processor is further configured for estimating values representative of the reduction of light intensity for elements of said light ray from said first projection coefficients.
